(19) United States
(12) Patent Application Publication
(10) Pub. No.: US 2023/0091722 A1
(43) Pub. Date: Mar. 23, 2023

(54) SYSTEM TO ENHANCE MEMORY PROTECTION ASSOCIATED WITH KERNEL OF OPERATING SYSTEM

(71) Applicant: MEDIATEK INC., Hsin-Chu (TW)

(72) Inventors: Chih-Hsiang Hsiao, Hsinchu City (TW); Hung-Wen Chien, Hsinchu City (TW); Yu-Chi Chu, Hsinchu City (TW); Pei-Lun Suei, Hsinchu City (TW)

(73) Assignee: MEDIATEK INC., Hsin-Chu (TW)

(21) Appl. No.: 17/978,995

(22) Filed: Nov. 2, 2022

Related U.S. Application Data
(63) Continuation-in-part of application No. 17/853,950, filed on Jun. 30, 2022.
(60) Provisional application No. 63/245,235, filed on Sep. 17, 2021.
(60) Provisional application No. 63/325,136, filed on Mar. 29, 2022.

(51) Int. Cl. G06F 3/06

(52) U.S. Cl. CPC G06F 3/0622; G06F 3/0629; G06F 3/0673

(57) ABSTRACT

A computing system includes a processor, and the processor is arranged to execute: a guest virtual machine (VM), a hypervisor, and a primary VM, wherein an operating system (OS) runs on the guest VM, and an application (APP) runs on the OS. The kernel of the OS includes a protection service module and a memory management unit (MMU) manager. The protection service module is arranged to receive at least one virtual address and a first size information sent by a client of the APP. The primary VM includes a protection manager, and the protection manager is arranged to obtain a physical address array and a second size information according to the at least one virtual address and the first size information sent by the protection service through the hypervisor.

### CROSS REFERENCE TO RELATED APPLICATION

This application is a continuation-in-part of U.S. application Ser. No. 17/853,950, filed on Jun. 30th, 2022, which claims the benefit of U.S. Provisional Application No. 63/245,235, filed on Sep. 17th, 2021. Further, this application claims the benefit of U.S. Provisional Application No. 63/325,136, filed on Mar. 29th, 2022. The contents of these applications are incorporated herein by reference.

### BACKGROUND

For conventional Android's high-level operating system (OS) that uses a monolithic OS (e.g. a Linux) as a kernel, protection of resources (e.g. a memory allocated by the Linux kernel, and the memory may be controlled by the Linux kernel for applications (APPs), drivers, and services in use) is implemented by the Linux kernel or a trusted execution environment (TEE). Under the condition that the resource protection is implemented by the Linux kernel, since the vulnerability of the Linux kernel, it is easy to become a springboard for attackers, causing failure of the resource protection. In addition, under the condition that the resource protection is implemented by the TEE, although the TEE may have high security, the TEE may have limited resources and large overhead, and the TEE is not good for function development. As a result, a novel system to protect the memory allocated by the kernel of the OS that will not degrade kernel performance and increase cost is urgently needed.

### SUMMARY

It is therefore one of the objectives of the present invention to provide a system to enhance memory protection associated with a kernel of an OS, to address the above-mentioned problems.

According to an embodiment of the present invention, a system to enhance memory protection associated with a kernel of an OS is provided. The system may include a processor, and the processor may be arranged to execute: a guest virtual machine (VM), a hypervisor, and a primary VM, wherein the OS may run on the guest VM, and an application (APP) may run on the OS. The kernel of the OS may include a protection service module and a memory management unit (MMU) manager. The protection service module may be arranged to receive at least one virtual address and a first size information corresponding to the at least one virtual address sent by a client of the APP. The MMU manager may be arranged to manage an MMU. The hypervisor may be arranged to receive the at least one virtual address and the first size information sent by the protection service module. The primary VM may include a protection manager, and the protection manager may be arranged to: receive the at least one virtual address and the first size information sent by the hypervisor; and obtain a physical address array and a second size information corresponding to the physical address array according to the at least one virtual address and the first size information.

According to an embodiment of the present invention, a method in a computing system of enhancing memory protection associated with a kernel of an operating system (OS) is provided. The method comprises: running the OS on a guest VM; running an application (APP) on the OS; receiving, by a hypervisor, at least one virtual address and a first size information corresponding to at least one virtual address sent by a client of the APP; receiving, by a primary VM, the at least one virtual address and the first size information sent by the hypervisor; obtaining, by the primary VM, a physical address array and a second size information corresponding to the physical address array according to the at least one virtual address and the first size information; and protecting a memory allocated by the kernel of the OS according to the physical address array and the second size information.

One of the benefits of the present invention is that, since the protection manager directly obtains the physical address array and the second size information from the MMU manager according to the at least one virtual address and the first size information sent by the hypervisor, the performance of the system can be improved. In addition, the system can be prevented from being tampered with or attacked in the process of transmitting the at least one virtual address and the first size information to the protection manager through the hypervisor, and the credibility of the at least one virtual address and the first size information can be ensured by protecting or monitoring the at least one L2P address mapping table. As a result, the security of the system can be guaranteed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a diagram illustrating a system to enhance memory protection associate with a kernel of an operating system (OS) according to an embodiment of the present invention.

FIG. 3 is a diagram illustrating a system to enhance memory protection associate with a kernel of an OS according to another embodiment of the present invention.

FIG. 4 is a diagram illustrating a system to enhance memory protection associate with a kernel of an OS according to still another embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

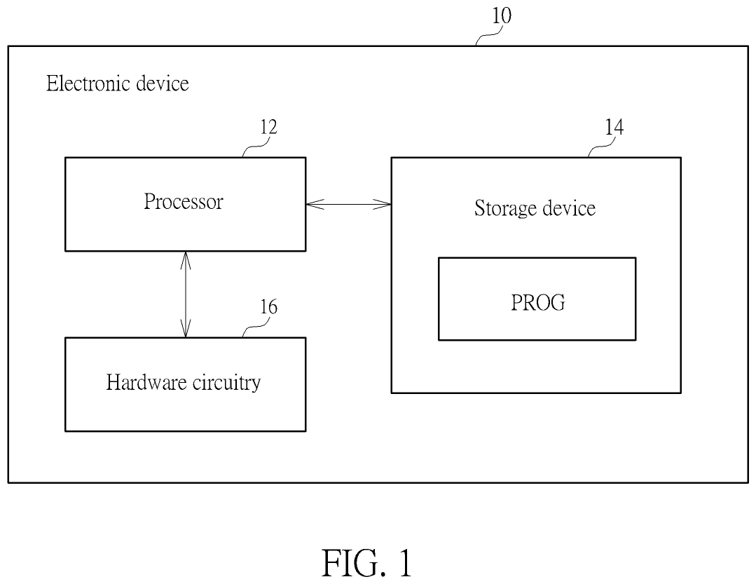

FIG. 1 is a diagram illustrating an electronic device 10 according to an embodiment of the present invention. By way of example, but not limitation, the electronic device 10 may be a portable device such as a smartphone or a tablet. The electronic device 10 may include a processor 12, a storage device 14, and a hardware circuitry 16. The processor 12 may be a single-core processor or a multi-core processor. The storage device 14 is a computer-readable medium, and is arranged to store computer program code PROG. The processor 12 is equipped with software execution capability. The computer program code PROG may include a plurality of software modules. Hence, when loaded and executed by the processor 12, the computer program code PROG instructs the processor 12 to perform designated functions of the software modules. The electronic device 10 may be regarded as a computer system using a computer program product that includes a computer-readable medium containing the computer program code. The hardware circuitry 16 is pure hardware that may consist of logic gates only, and performs designated functions without software execution. Regarding a system to enhance memory protection associated with a kernel of an operating system (OS) as proposed by the present invention, it may be embodied on the electronic device 10. For example, the system may include software-based functions implemented by computer program code PROG running on the processor 12 and hardware-based functions implemented by the hardware circuitry 16.

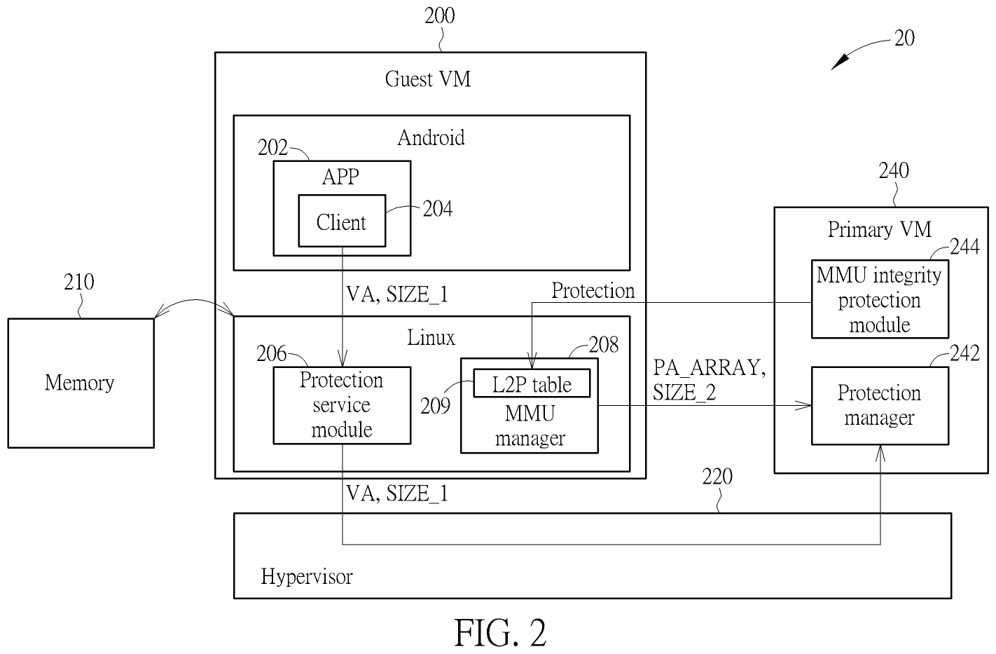

FIG. 2 is a diagram illustrating a system 20 that is capable of enhancing memory protection associated with a kernel of an OS according to an embodiment of the present invention. The system 20 may include a processor (e.g. the processor 12 shown in FIG. 1). The processor may be arranged to execute software modules, including a guest virtual machine (VM) 200, a hypervisor 220, and a primary VM 240. Android may run on the guest VM 200 (i.e. the OS of the guest VM 200 is Android) , an application (APP) 202 may run on the Android, and a kernel of the Android may be Linux (for brevity, hereafter labeled as “Linux kernel”). In order to enhance the protection of a memory 210 allocated by the Linux kernel (e.g. a memory controlled by the Linux kernel for APPs, drivers, and services in use), a client 204 of the APP 202 may send at least one virtual address VA and a first size information SIZE_1 corresponding to the at least one virtual address VA to the Linux kernel, wherein the at least one virtual address VA may represent the virtual address(es) of the memory 210, and the first size information SIZE_1 may represent the size of the memory 210.

The Linux kernel may include a protection service module 206 and a memory management unit (MMU) manager 208. The protection service module 206 may be arranged to receive at least one virtual address VA and the first size information SIZE_1 sent by the client 204 of the APP 202, for protecting the memory 210. The MMU manager 208 may be arranged to manage an MMU (not shown in FIG. 1). In this embodiment, the MMU manager 208 may include at least one logical-to-physical (L2P) address mapping table 209 (labeled as “L2P table” in FIG. 2), and the MMU manager 208 may be arranged to translate the at least one virtual address VA into the at least one physical address according to the at least one L2P address mapping table 209, to generate a physical address array PA_ARRAY and a second size information SIZE_2 corresponding to the physical address PA_ARRAY, wherein the second size information SIZE_2 may represent the size of the physical address array PA_ARRAY. The hypervisor 220 may be arranged to receive the at least one virtual address VA and the first size information SIZE_1 sent by the protection service module 206.

The primary VM 240 may include a protection manager 242, wherein the protection manager 242 may be arranged to: receive the at least one virtual address VA and the first size information SIZE_1 sent by the hypervisor 220; obtain the physical address array PA_ARRAY and the second size information SIZE_2 from the MMU manager 208 according to the at least one virtual address VA and the first size information SIZE_1; and protect the memory 210 according to the physical address array PA_ARRAY and the second size information SIZE_2. In addition, the primary VM 240 may further include an MMU integrity protection module 244. The MMU integrity protection module 244 may be arranged to protect the at least one L2P address mapping table 209 (labeled as “Protection” in FIG. 2).

Consider a case where the primary VM 240 only includes the protection manager 242, and receives the physical address array PA_ARRAY and the second size information SIZE_2 from the hypervisor 220, that is, the protection service module 206 obtains the physical address array PA_ARRAY and the second size information SIZE_2 from the MMU manager 208 according to the at least one virtual address VA and the first size information SIZE_1, and sends the physical address array PA_ARRAY and the second size information SIZE_2 to the protection manager 242 through the hypervisor 220. In this case, in terms of security, the credibility of the physical address array PA_ARRAY obtained from the MMA manager 208 cannot be confirmed, and the obtained physical address array PA_ARRAY may be tampered with or attacked (e.g. the attackers may utilize a fake protection service module to attack the system 20) in the process of transmitting it to the protection manager 242 through the hypervisor 220. In terms of performance, transmitting the physical address array PA_ARRAY to the protection manager 242 through the hypervisor 220 may degrade the performance of the system 20. For example, to protect a memory with size of 32 megabytes (MB), it is necessary to transmit a physical address array with size of 34 kilobytes (KB).

Compared with this case, in the system 20 shown in FIG. 2, the at least one virtual address VA and the first size information SIZE_1 are transmitted from the Linux kernel to the protection manager 242 through the hypervisor 220, and the system 20 may be prevented from being tampered with or attacked in the process of transmitting the at least one virtual address VA and the first size information SIZE_1 to the protection manager 242 through the hypervisor 220. The MMU integrity protection module 244 may be arranged to ensure the credibility of the at least one virtual address VA and the first size information SIZE_1 by protecting the at least one L2P address mapping table 209. As a result, the system 20 shown in FIG. 2 is much safer than that in this case. In addition, the protection manager 242 can directly obtain the physical address array PA_ARRAY and the second size information SIZE_2 from the MMU manager 208 according to the at least one virtual address VA and the first size information SIZE_1 sent by the hypervisor 220, which can improve the performance of the system 20.

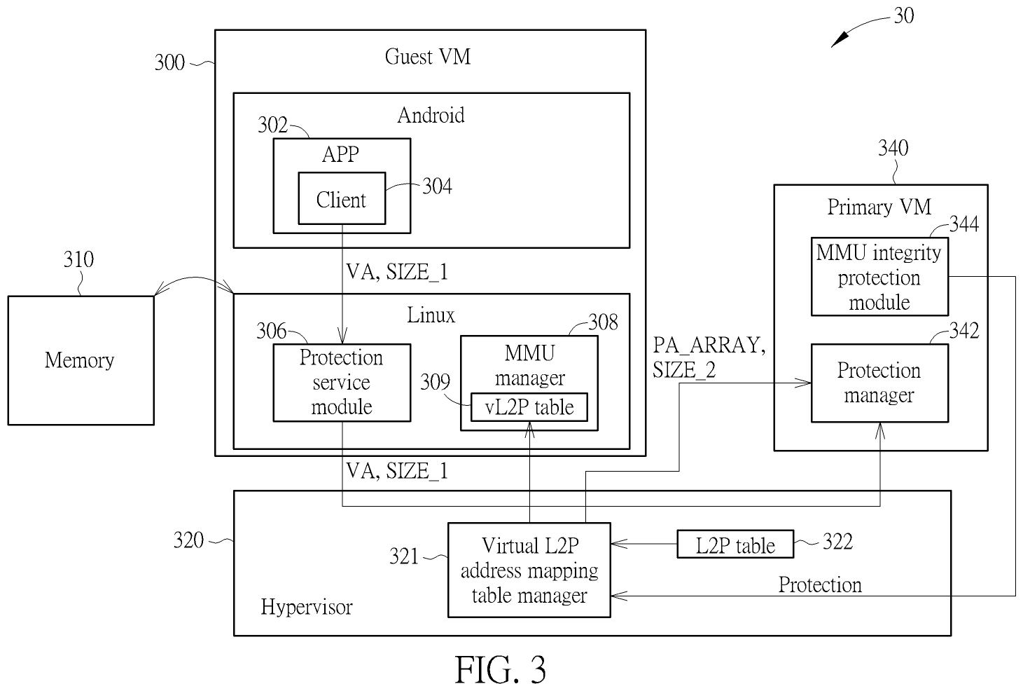

However, protecting the at least one L2P address mapping table 209 may degrade performance of the Linux kernel. In addition, write mechanism for the at least one L2P address mapping table 209 may be provided to the MMU manager 208 by the MMU integrity protection module 244, wherein the high overhead of the write mechanism may affect the performance of the MMU. In order to address the above-mentioned problems, at least one virtual L2P address mapping table may be provided to the MMU manager 208. Please refer to FIG. 3. FIG. 3 is a diagram illustrating a system 30 capable of enhancing memory protection associate with a kernel of an OS according to another embodiment of the present invention. The system 30 may include a processor (e.g. the processor 12 shown in FIG. 1). The processor may be arranged to execute software modules, including a guest VM 300, a hypervisor 320, and a primary VM 340, wherein Android may run on the guest VM 300 (i.e. the OS of the guest VM 300 is Android), an APP 302 may run on the Android, and a kernel of the Android may be Linux. In order to protect a memory 310 allocated by the Linux kernel (e.g. a memory controlled by the Linux kernel for APPs, drivers, and services in use), a client 304 of the APP 302 may send at least one virtual address VA and a first size information SIZE_1 corresponding to the at least one virtual address VA to the Linux kernel, wherein the at least one virtual address VA may represent the virtual address (es) of the memory 310, and the first size information SIZE_1 may represent the size of the memory 310.

The Linux kernel may include a protection service module 306 and an MMU manager 308. The protection service module 306 may be arranged to receive the at least one virtual address VA and the first size information SIZE_1 sent by the client 304 of the APP 302, for protecting the memory 310. The MMU manager 308 may be arranged to manage an MMU (not shown in FIG. 3) . The hypervisor 320 maybe arranged to receive the at least one virtual address VA and the first size information SIZE_1 sent by the protection service module 206. In addition, the hypervisor 320 may include a virtual L2P address mapping table manager 321, wherein the virtual L2P address mapping table manager 321 maybe arranged to: receive at least one L2P address mapping table 322 (labeled as “L2P table” in FIG. 3), translate the at least one virtual address VA into at least one physical address according to the at least one L2P address mapping table 322, to generate a physical address array PA_ARRAY and a second size information SIZE_2 corresponding to the physical address array PA_ARRAY, and provide at least one virtual L2P address mapping table 309 (labeled as “vL2P table” in FIG. 3) to the MMU manager 308, wherein the second size information SIZE_2 may represent the size of the physical address array PA_ARRAY.

The primary VM 340 may include a protection manager 342, wherein the protection manager 342 may be arranged to: receive the at least one virtual address VA and the first size information SIZE_1 sent by the hypervisor 320; obtain the physical address array PA_ARRAY and the second size information SIZE_2 from the virtual L2P address mapping table manager 321 according to the at least one virtual address VA and the first size information SIZE_1; and protect the memory 310 according to the physical address array PA_ARRAY and the second size information SIZE_2. In addition, the primary VM 340 may further include an MMU integrity protection module 344. In this embodiment, The MMU integrity protection module 344 may be arranged to protect the virtual L2P address mapping table manager 321 (labeled as “Protection” in FIG. 3).

Compared with the system 20 shown in FIG. 2, the system 30 shown in FIG. 3 is not required to provide the write mechanism for the at least one L2P mapping table to the MMU manager 308 by the MMU integrity protection module 344, which can avoid high overhead of the write mechanism affecting the performance of the MMU. In addition, the MMU integrity protection module 344 protects not the at least one L2P mapping table but the virtual L2P address mapping table manager 321. In this way, the degradation of the performance of the Linux kernel caused by protecting the at least one L2P address mapping table can be improved.

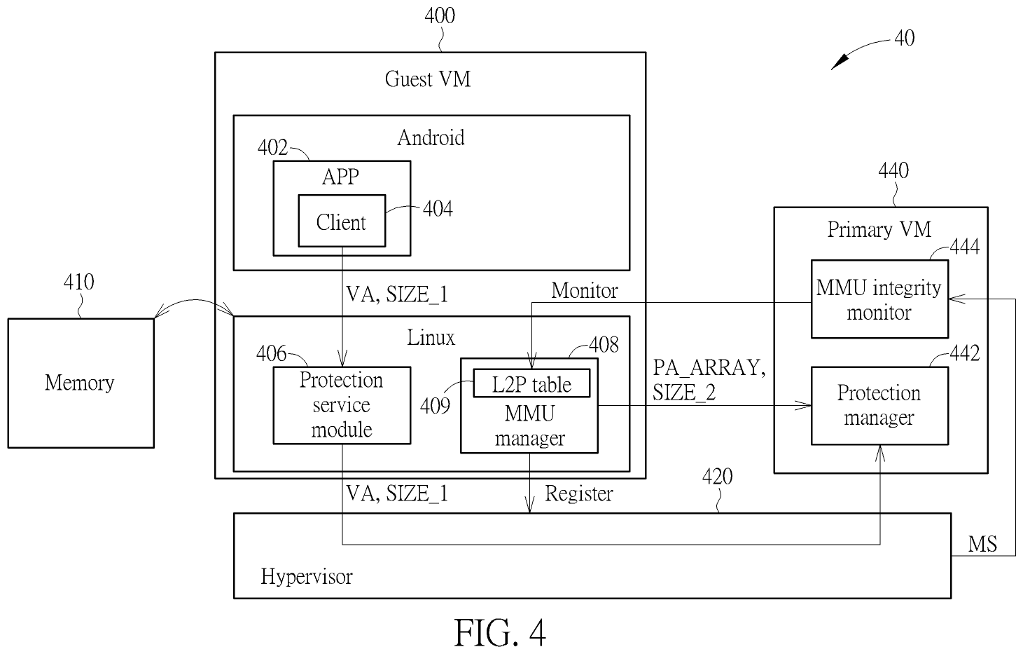

FIG. 4 is a diagram illustrating a system 40 capable of enhancing memory protection associated with a kernel of an OS according to still another embodiment of the present invention. The system 40 may include a processor (e.g. the processor 12 shown in FIG. 1). The processor may be arranged to execute software modules, including a guest VM 400, a hypervisor 420, and a primary VM 440, wherein Android may run on the guest VM 400 (i.e. the OS of the guest VM 400 is Android), an APP 402 may run on the Android, and a kernel of the Android may be Linux. In order to protect a memory 410 allocated by the Linux kernel (e.g. a memory controlled by the Linux kernel for APPs, drivers, and services in use), a client 404 of the APP 402 may send at least one virtual address VA and a first size information SIZE_1 corresponding to the at least one virtual address VA to the Linux kernel, wherein the at least one virtual address VA may represent the virtual address(es) of the memory 410, and the first size information SIZE_1 may represent the size of the memory 410.

The Linux kernel may include a protection service module 406 and an MMU manager 408. The protection service module 406 may be arranged to receive the at least one virtual address VA and the first size information SIZE_1 sent by the client 404 of the APP 402, for protecting the memory 410. The MMU manager 408 may be arranged to manage an MMU (not shown in FIG. 4),In this embodiment, the MMU manager 408 may include at least one L2P address mapping table 409 (labeled as “L2P table” in FIG. 4), and may translate the at least one virtual address VA into at least one physical address according to the at least one L2P address mapping table 409, to generate a physical address array PA_ARRAY and a second size information SIZE_2 corresponding to the physical address array PA_ARRAY, wherein the second size information SIZE_2 may represent the size of the physical address array PA_ARRAY. The hypervisor 420 maybe arranged to receive the at least one virtual address VA and the first size information SIZE_1 sent by the protection service module 406.

The primary VM 440 may include a protection manager 442, wherein the protection manager 442 may be arranged to: receive the at least one virtual address VA and the first size information SIZE_1 sent by the hypervisor 420; obtain the physical address array PA_ARRAY and the second size information SIZE_2 from the MMU manager 408 according to the at least one virtual address VA and the first size information SIZE_1; and protect the memory 410 according to the physical address array PA_ARRAY and the second size information SIZE_2. The difference between the system 20 shown in FIG. 2 and the system 40 shown in FIG. 4 is that, instead of an MMU integrity protection module, the primary VM 440 may further include an MMU integrity monitor 444. The MMU manager 408 may be registered to the hypervisor 420 (labeled as “Register” in FIG. 4). The hypervisor 420 maybe further arranged to send a monitoring signal MS to the primary VM 440 (more particularly, the MMU integrity monitor 444), for monitoring the MMU manager 408.

In this embodiment, the MMU manager 408 is legal to the system 40, and the MMU integrity monitor 444 may be arranged to monitor access (e.g. read or write) of the at least one L2P address mapping table 409 according to the monitoring signal MS sent by the hypervisor 420 (labeled as “Monitor” in FIG. 4), to determine whether the access of the at least one L2P address mapping table 409 is illegal to the system 40. In response to the access of the at least one L2P address mapping table 409 being illegal to the system 40, the MMU integrity monitor 444 maybe further arranged to prevent the protection manager 442 from protecting the memory 410 allocated by the Linux kernel. Compared with the system 20 shown in FIG. 2, the system 40 shown in FIG. 4 has a better performance of the Linux kernel. However, the system 40 with the monitoring of the MMU manager 408 is not safer than the system 20 with the protection of the MMU manager 208, and it is necessary to ensure that the MMU manager 408 is legal to the system 40.

In some embodiments, it is unnecessary to ensure that the MMU manager 408 is legal to the system 40. Whether or not the MMU manager 408 is legal to the system 40, the MMU integrity monitor 444 may be arranged to monitor resource of the MMU manager 408, to determine whether the resource of the MMU manager 408 is illegal to the system 40. In response to the resource of the MMU manager 408 being illegal to the system 40, the MMU integrity monitor 444 may be further arranged to prevent the protection manager 442 from protecting the memory 410.

In summary, since the protection manager 242/442 directly obtains the physical address array PA_ARRAY and the second size information SIZE_2 from the MMU manager 208/408 according to the at least one virtual address VA and the first size information SIZE_1 sent by the hypervisor 220/420, the performance of the system 20/40 can be improved. In addition, the system 20/40 can be prevented from being tampered with or attacked in the process of transmitting the at least one virtual address VA and the first size information SIZE_1 to the protection manager 242/442 through the hypervisor 220/420, and the credibility of the at least one virtual address VA and the first size information SIZE_1 can be ensured by protecting or monitoring the at least one L2P address mapping. As a result, the security of the system 20/40 can be guaranteed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A computing system, comprising:
a processor, arranged to execute:
a guest virtual machine (VM), wherein an operating system (OS) runs on the guest VM, an application (APP) runs on the OS, and a kernel of the OS comprises:
a protection service module, arranged to receive at least one virtual address and a first size information corresponding to the at least one virtual address sent by a client of the APP; and
a memory management unit (MMU) manager, arranged to manage an MMU;
a hypervisor, arranged to receive the at least one virtual address and the first size information sent by the protection service module; and
a primary VM, comprising:
a protection manager, arranged to:
receive the at least one virtual address and the first size information sent by the hypervisor; and
obtain a physical address array and a second size information corresponding to the physical address array according to the at least one virtual address and the first size information.

2. The computing system of claim 1, wherein the MMU manager comprises at least one logical-to-physical (L2P) address mapping table, and the MMU manager is arranged to translate the at least one virtual address into the at least one physical address according to the at least one L2P mapping table, to generate the physical address array and the second size information.

3. The computing system of claim 1, wherein the protection manager is arranged to obtain the physical address array and the second size information from the MMU manager.

4. The computing system of claim 2, wherein the primary VM further comprises:
an MMU integrity protection module, arranged to protect the at least one L2P address mapping table.

5. The computing system of claim 1, wherein the hypervisor comprises a virtual logical-to-physical (L2P) address mapping table manager, the virtual L2P address mapping table manager is arranged to receive at least one L2P address mapping table, translate the at least one virtual address into the at least one physical address according to the at least one L2P address mapping table, to generate the physical address array and the second size information, and provide a virtual L2P address mapping table to the MMU manager.

6. The computing system of claim 5, wherein the protection manager is arranged to obtain the physical address array and the second size information from the virtual L2P address mapping table manager according to the at least one virtual address and the first size information.

7. The computing system of claim 5, wherein the primary VM further comprises:
an MMU integrity protection module, arranged to protect the virtual L2P address mapping table manager.

8. The computing system of claim 1, wherein the protection manager is arranged to obtain the physical address array and the second size information from the MMU manager according to the at least one virtual address and the first size information, the MMU manager is registered to the hypervisor, and the hypervisor is further arranged to send a monitoring signal to the primary VM for monitoring the MMU manager.

9. The computing system of claim 8, wherein the MMU manager is legal to the system, the MMU manager comprises at least one logical-to-physical (L2P) address mapping table, the MMU manager is arranged to translate the at least one virtual address into the at least one physical address according to the at least one L2P address mapping table, to generate the physical address array and the second size information, and the primary VM further comprises:
an MMU integrity monitor, arranged to monitor access of the at least one L2P address mapping table according to the monitoring signal sent by the hypervisor, to determine whether the access of the at least one L2P address mapping table is illegal to the system.

10. The computing system of claim 9, wherein in response to the access of the at least one MMU translation table being illegal to the system, the MMU integrity monitor is further arranged to prevent the protection manager from protecting the memory allocated by the kernel of the OS.

11. The computing system of claim 8, wherein the primary VM further comprises:
an MMU integrity monitor, arranged to monitor resource of the MMU manager, to determine whether the resource of the MMU manager is illegal to the system.

12. The computing system of claim 11, wherein in response to the resource of the MMU manager being illegal to the system, the MMU integrity monitor is further arranged to prevent the protection manager from protecting the memory allocated by the kernel of the OS.

13. In a computing system having a processor, a method of enhancing memory protection associated with a kernel of an operating system (OS) comprising:
running the OS on a guest virtual machine (VM);
running an application (APP) on the OS;
receiving, by a hypervisor, at least one virtual address and a first size information corresponding to at least one virtual address sent by a client of the APP;
receiving, by a primary VM, the at least one virtual address and the first size information sent by the hypervisor;
obtaining, by the primary VM, a physical address array and a second size information corresponding to the physical address array according to the at least one virtual address and the first size information; and
protecting a memory allocated by the kernel of the OS according to the physical address array and the second size information.
